(19) United States
(12) Patent Application Publication
(10) Pub. No.: US 2016/0191107 A1
(43) Pub. Date: Jun. 30, 2016

(54) RADIO FREQUENCY FRONT END CIRCUITRY FOR CARRIER AGGREGATION

(71) Applicant: RF Micro Devices, Inc., Greensboro, NC (US)

(72) Inventor: Nadim Khlat, Cugnaux (FR)

(21) Appl. No.: 14/978,499

(22) Filed: Dec. 22, 2015

Related U.S. Application Data
(60) Provisional application No. 62/096,803, filed on Dec. 24, 2014.
(60) Provisional application No. 62/120,299, filed on Feb. 24, 2015.
(60) Provisional application No. 62/130,118, filed on Mar. 9, 2015.

(51) Int. Cl. H04B 1/48

(52) U.S. Cl. CPC H04B 1/48

(57) ABSTRACT

RF front end circuitry includes at least three antennas, RF filtering circuitry, antenna switching circuitry coupled between the antennas and the RF filtering circuitry, and transceiver circuitry coupled to the RF filtering circuitry. The RF front end circuitry may support at least five carrier aggregation configurations between eight different operating bands. Two of the antennas are configured to operate at mid/high-band frequencies, while one of the antennas is configured only to operate at high-band frequencies. The third antenna along with the arrangement of filters in the RF filtering circuitry is used to support at least two additional configurations over those achievable by conventional RF front end circuitry.

### RELATED APPLICATIONS

This application claims the benefit of U.S. provisional patent application No. 62/096,803, filed Dec. 24, 2014, U.S. provisional patent application No. 62/120,299, filed Feb. 24, 2015, and U.S. provisional patent application No. 62/130,118, filed Mar. 9, 2015, the disclosures of which are incorporated herein by reference in their entirety.

### FIELD OF THE DISCLOSURE

The present disclosure relates to radio frequency (RF) front end circuitry, and specifically to RF front end circuitry configured to support multiple carrier aggregation configurations.

### BACKGROUND

Modern mobile telecommunications standards continue to demand increasingly greater rates of data exchange (data rates). One way to increase the data rate of a wireless communications device is through the use of carrier aggregation. Carrier aggregation allows a single wireless communications device to aggregate bandwidth across one or more operating bands in the wireless spectrum. The increased bandwidth achieved as a result of carrier aggregation allows a wireless communications device to obtain higher data rates than have previously been available.

FIGS. 1A and 1B show tables describing a number of wireless communication operating bands in the wireless spectrum. Specifically, FIG. 1A shows a table describing a number of frequency division duplexing (FDD) operating bands, while FIG. 1B shows a table describing a number of time division duplexing (TDD) operating bands as defined by Third Generation Partnership Project (3GPP) Long Term Evolution (LTE) standards. The first column in FIGS. 1A and 1B indicates the operating band number for each one of the operating bands. The second column in FIGS. 1A and 1B indicate the uplink frequency band for each one of the operating bands. The third column in FIG. 1A indicates the downlink frequency band for each one of the operating bands. Since the operating bands shown in FIG. 1B are TDD operating bands, the uplink and downlink frequency bands are the same. In non-carrier aggregation configurations, a wireless communications device will generally communicate using a single portion of the uplink or downlink frequency bands within a single operating band. In carrier aggregation applications, however, a wireless communications device may aggregate bandwidth across a single operating band or multiple operating bands in order to increase the data rate of the device.

FIG. 2A shows a diagram representing a conventional, non-carrier aggregation configuration for a wireless communications device. In this conventional configuration, a wireless communications device communicates using a single portion of a wireless spectrum 10 within a single operating band 12. Under the conventional approach, the data rate of the wireless communications device is constrained by the limited available bandwidth.

FIGS. 2B-2D show diagrams representing a variety of carrier aggregation configurations for a wireless communications device. FIG. 2B shows an example of contiguous intra-band carrier aggregation, in which the aggregated portions of the wireless spectrum 14A and 14B are located directly adjacent to one another and are in the same operating band 16. FIG. 2C shows an example of non-contiguous intra-band carrier aggregation, in which the aggregated portions of the wireless spectrum 18A and 18B are located within the same operating band 20, but are not directly adjacent to one another. Finally, FIG. 2D shows an example of inter-band carrier aggregation, in which the aggregated portions of the wireless spectrum 22A and 22B are located in different operating bands 24 and 26. A modern wireless communications device should be capable of supporting each one of the previously described carrier aggregation configurations.

The various carrier aggregation configurations discussed above can be performed between two or more FDD operating bands, two or more TDD operating bands, or a combination thereof. Generally, a wireless communications device will aggregate bandwidth when receiving data (i.e., during downlink), but will use a single operating band when transmitting data (i.e., during uplink). However, carrier aggregation may also be used during data transfer to increase uplink throughput.

FIG. 3 shows a schematic representation of conventional radio frequency (RF) front end circuitry 28 configured to support at least one carrier aggregation configuration. The conventional RF front end circuitry 28 includes a first antenna 30A, a second antenna 30B, antenna switching circuitry 32 coupled to the first antenna 30A and the second antenna 30B, RF filtering circuitry 34 coupled between the antenna switching circuitry 32 and a number of input/output nodes 36 (shown individually as 40A through 40U), and transceiver circuitry 38 coupled to the input/output nodes 36. The RF filtering circuitry 34 includes a number of filters 40 (shown individually as 40A through 40U), which are grouped into first RF multiplexer circuitry 42A, second RF multiplexer circuitry 42B, third RF multiplexer circuitry 42C, fourth RF multiplexer circuitry 42D, and fifth RF multiplexer circuitry 42E. One of the filters 40 is not grouped with any other filters, as discussed below. The first RF multiplexer circuitry 42A and the second RF multiplexer circuitry 42B are hexaplexers, the third RF multiplexer circuitry 42C and the fourth RF multiplexer circuitry 42D are triplexers, and the fifth RF multiplexer circuitry 42E is a duplexer. Details of the first RF multiplexer circuitry 42A, the second RF multiplexer circuitry 42B, the third RF multiplexer circuitry 42C, the fourth RF multiplexer circuitry 42D, and the fifth RF multiplexer circuitry 42E are shown in FIGS. 4A through 4E.

FIG. 4A shows a block diagram of the first RF multiplexer circuitry 42A. The first RF multiplexer circuitry 42A includes a first filter 40A coupled between a first common node 44 and a first input/output node 36A, a second filter 40B coupled between the first common node 44 and a second input/output node 36B, a third filter 40C coupled between the first common node 44 and a third input/output node 36C, a fourth filter 40D coupled between the first common node 44 and a fourth input/output node 36D, a fifth filter 40E coupled between the first common node 44 and a fifth input/output node 36E, and a sixth filter 40F coupled between the first common node 44 and a sixth input/output node 36F.

FIG. 4B shows a block diagram of the second RF multiplexer circuitry 42B. The second RF multiplexer circuitry 42B includes a seventh filter 40G coupled between a second common node 46 and a seventh input/output node 36G, an eighth filter 40H coupled between the second common node 46 and an eighth input/output node 36H, a ninth filter 40I coupled between the second common node 46 and a ninth input/output node 36I, a tenth filter 40J coupled between the second common node 46 and a tenth input/output node 36J, an eleventh filter 40K coupled between the second common node and an eleventh input/output node 36K, and a twelfth filter 40L coupled between the second common node 46 and a twelfth input/output node 36L.

FIG. 4C shows a block diagram of the third RF multiplexer circuitry 42C. The third RF multiplexer circuitry 42C includes a thirteenth filter 40M coupled between a third common node 48 and a thirteenth input/output node 36M, a fourteenth filter 40N coupled between the third common node 48 and a fourteenth input/output node 36N, and a fifteenth filter 40O coupled between the third common node 48 and a fifteenth input/output node 36O.

FIG. 4D shows a block diagram of the fourth RF multiplexer circuitry 42D. The fourth RF multiplexer circuitry 42D includes a sixteenth filter 40P coupled between a fourth common node 50 and a sixteenth input/output node 36P, a seventeenth filter 40Q coupled between the fourth common node 50 and a seventeenth input/output node 36Q, and an eighteenth filter 40R coupled between the fourth common node 50 and an eighteenth input/output node 36R.

FIG. 4E shows a block diagram of the fifth RF multiplexer circuitry 42E. The fifth RF multiplexer circuitry 42E includes a nineteenth filter 40S coupled between a fifth common node 52 and a nineteenth input/output node 36S and a twentieth filter 40T coupled between the fifth common node 52 and a twentieth input/output node 36T.

FIG. 4F shows a twenty-first filter 40U coupled between an isolated filter node 54 and a twenty-first input/output node 36U, such that the twenty-first filter 40U is not grouped with any other filters.

The RF filtering circuitry 34 is configured to selectively pass RF transmit signals and RF receive signals within a first operating band (band 4), a second operating band (band 25), a third operating band (band 1), a fourth operating band (band 30), a fifth operating band (band 3), a sixth operating band (band 7), a seventh operating band (band 39), and an eighth operating band (band 41) between the antenna switching circuitry 32 and the transceiver circuitry 38. All numbered operating bands referred to herein are addressed according to the operating bands defined in 3GPP LTE standards as shown in FIG. 1. As discussed below, the RF filtering circuitry 34 facilitates at least one carrier aggregation configuration in the conventional RF front end circuitry 28.

The filter response of each one of the filters 40 includes a pass band configured to pass RF signals within a particular frequency range, while attenuating other signals. Specifically, the pass band of each one of the filters 40 is designed to pass only those signals within a transmit or receive frequency band of a particular operating band (or multiple operating bands), such as the transmit and receive frequency bands shown above for each operating band in FIG. 1. The particular filter response of each one of the filters 40 in the RF filtering circuitry 34 is shown in Table 1:

| Filter | Pass band |
|---|---|
| First filter 40A | Band 4 (TX) |
| Second filter 40B | Band 25 (TX) |
| Third filter 40C | Band 25 (RX) |
| Fourth filter 40D | Band 4/1 (RX) |
| Fifth filter 40E | Band 30 (TX) |
| Sixth filter 40F | Band 30 (RX) |
| Seventh filter 40G | Band 4/3 (TX) |
| Eighth filter 40H | Band 3 (RX) |
| Ninth filter 40I | Band 1 (TX) |
| Tenth filter 40J | Band 4/1 (RX) |
| Eleventh filter 40K | Band 7 (TX) |
| Twelfth filter 40L | Band 7 (RX) |
| Thirteenth filter 40M | Band 25 (RX) |
| Fourteenth filter 40N | Band 4/1 (RX) |
| Fifteenth filter 40O | Band 30 (RX) |
| Sixteenth filter 40P | Band 3 (RX) |
| Seventeenth filter 40Q | Band 4/1 (RX) |
| Eighteenth filter 40R | Band 7 (RX) |
| Nineteenth filter 40S | Band 39 (RX) |
| Twentieth filter 40T | Band 41 (RX) |
| Twenty-first filter 40U | Band 41 (RX) |

The conventional RF front end circuitry 28 is capable of operating in a standard (i.e., non-carrier aggregation) mode in any one of the first operating band (band 4), the second operating band (band 25), the third operating band (band 1), the fourth operating band (band 30), the fifth operating band (band 3), and the sixth operating band (band 7). Further, the conventional RF front end circuitry 28 may receive but not transmit signals within the seventh operating band (band 39) and the eighth operating band (band 41). During standard modes, a first one of the antennas 30 is used to transmit and receive signals within a single operating band, while a second one of the antennas 30 is used to receive a diversity or multiple-input-multiple-output (MIMO) signal within the same operating band. The particular one of the antennas 30 used for transmission may be changed based on one or more performance characteristics of each one of the antennas 30 (e.g., voltage standing wave ratio), and may be dynamically swapped by the antenna switching circuitry 32 in order to optimize transmission and/or reception. Details of the connections made by the antenna switching circuitry 32 in each one of the standard configurations are described in Table 2:

| Operating configuration | Antenna connections |
|---|---|
| Band 4-standard | First RF multiplexer circuitry 42A |
| | Third RF multiplexer circuitry 42C |
| Band 25-standard | First RF multiplexer circuitry 42A |
| | Third RF multiplexer circuitry 42C |
| Band 1-standard | Second RF multiplexer circuitry 42B |
| | Fourth RF multiplexer circuitry 42D |
| Band 30-standard | First RF multiplexer circuitry 42A |
| | Third RF multiplexer circuitry 42C |
| Band 3-standard | Second RF multiplexer circuitry 42B |
| | Fourth RF multiplexer circuitry 42D |
| Band 7-standard | Second RF multiplexer circuitry 42B |
| | Fourth RF multiplexer circuitry 42D |
| Band 39-standard (RX only) | Fifth RF multiplexer circuitry 42E (no |
| | diversity/MIMO) |
| Band 41-standard (RX only) | Fifth RF multiplexer circuitry 42E |
| | Twenty-first filter 40U |

The first column in Table 2 indicates the particular operating band in which the conventional RF front end circuitry 28 is configured to transmit and/or receive RF signals. The second column in Table 2 indicates which filters or groups of filters in the RF filtering circuitry 34 are connected to either the first antenna 30A or the second antenna 30B. For most of the standard modes, a first filter 40 or group of filters 40 is connected to a first one of the antennas 30 for primary transmission and reception of RF signals within a particular operating band, while a second filter 40 or group of filters 40 is connected to a second one of the antennas 30 for reception of diversity or MIMO receive signals within the same operating band. In some configurations (e.g., in TDD operating bands such as the seventh operating band, Band 39), however, diversity or MIMO signals may not be used. In general, the filters 40 in the first RF multiplexer circuitry 42A, the second RF multiplexer circuitry 42B, and the fifth RF multiplexer circuitry 42E are used to transmit and receive primary signals, while the filters 40 in the third RF multiplexer 42C, the fourth RF multiplexer circuitry 42D, and the twenty-first filter 40U are used for the reception of diversity or MIMO receive signals. When connected to an antenna 30, the particular filter 40 or group of filters 40 isolates RF receive signals from the antenna 30 that are within the receive band of the operating band from other signals and delivers the isolated RF receive signals to the transceiver circuitry 38 for further processing. Further, the particular filter 40 or group of filters 40 passes RF transmit signals within the operating band provided at the appropriate input/output node 36 to the connected antenna 30 for transmission.

The conventional RF front end circuitry 28 may operate in a first carrier aggregation configuration in which bandwidth is aggregated between the first operating band (band 4), the second operating band (band 25), and the fourth operating band (band 30), a second carrier aggregation configuration in which bandwidth is aggregated between the third operating band (band 1), the fifth operating band (band 3), and the sixth operating band (band 7), and a third carrier aggregation configuration in which bandwidth is aggregated between the seventh operating band (band 39) and the eighth operating band (band 41). Details of the connections made by the antenna switching circuitry 32 in each one of the carrier aggregation configurations are described in Table 3:

| Operating configuration | Antenna connections |
|---|---|
| Bands 4-25-30 (carrier aggregation) | First RF multiplexer circuitry 42A |
| | Third RF multiplexer circuitry 42C |
| Bands 1-3-7 (carrier aggregation) | Second RF multiplexer circuitry 42B |
| | Fourth RF multiplexer circuitry 42D |
| Bands 39-41 (carrier aggregation- | Fifth RF multiplexer circuitry 42E |
| RX only) | Twenty-first filter 40U |

The first column in Table 3 indicates the particular operating bands in which the conventional RF front end circuitry 28 is configured to aggregate bandwidth. The second column in Table 3 indicates which filters or groups of filters in the RF filtering circuitry 34 are connected to either the first antenna 30A or the second antenna 30B. For most of the carrier aggregation configurations, a first filter 40 or group of filters 40 is connected to a first one of the antennas 30 for transmission of RF signals within one of the particular operating bands and primary reception of RF signals within the particular operating bands, while a second filter 40 or group of filters 40 is connected to a second one of the antennas 30 for reception of diversity or MIMO receive signals within the same operating bands. Generally, transmission of RF signals occurs only within one of the operating bands, while reception occurs on all of the indicated operating bands. In the first and second carrier aggregation configurations shown, any one of the operating bands may be used for transmission and reception, while the remaining bands are used only for reception. In the third carrier aggregation configuration, signals are only received, and not transmitted on either operating band. When connected to the antenna 30, the particular filter 40 or group of filters 40 isolates RF receive signals from the antenna 30 that are within the receive bands of the operating bands from other signals and delivers the isolated RF receive signals to the transceiver circuitry 38 for further processing. Further, the particular filter 40 or group of filters 40 passes RF transmit signals within the one of the operating bands provided at the appropriate input/output node 36 to the connected antenna 30 for transmission.

As wireless communications standards continue to evolve, additional carrier aggregation configurations become increasingly desirable. For example, there is a current demand for carrier aggregation between the second operating band (band 25) and the eighth operating band (band 41), and for carrier aggregation between the third operating band (band 1) and the eighth operating band (band 41). The conventional RF front end circuitry 28 described above is incapable of supporting such carrier aggregation configurations. While there have been attempts to adapt the conventional RF front end circuitry 28 to do so, they generally involve adding additional filters in the RF filtering circuitry 34, which increases the price and size of the circuitry and further results in a significant decrease in one or more performance factors such as insertion loss and isolation.

Accordingly, there is a need for RF front end circuitry that is capable of supporting additional carrier aggregation configurations with minimal impact on the size, cost, and performance thereof.

### SUMMARY

The present disclosure relates to radio frequency (RF) front end circuitry, and specifically to RF front end circuitry configured to support multiple carrier aggregation configurations. In one embodiment, RF front end circuitry includes a number of antennas, RF filtering circuitry, antenna switching circuitry coupled between the antennas and the RF filtering circuitry, and transceiver circuitry coupled to the RF filtering circuitry. The antennas include a first antenna, a second antenna, and a third antenna. The first antenna and the second antenna are configured to operate at mid/high-band frequencies, while the third antenna is configured to operate at high-band frequencies. The RF front end circuitry is configured to connect one or more mid/high-band filters in the RF filtering circuitry to the first antenna and the second antenna via the antenna switching circuitry such that an RF transmit signal within a mid/high-band operating band is provided to one of the first antenna and the second antenna, and at least two RF receive signals within the mid/high-band operating band received at the first antenna and the second antenna, respectively, are separately delivered to the transceiver circuitry. Further, the RF front end circuitry is configured to connect one or more high-band filters in the RF filtering circuitry to the second antenna and the third antenna via the antenna switching circuitry such that at least two RF receive signals within a high-band operating band received at the second antenna and the third antenna, respectively, are separately delivered to the transceiver circuitry. By providing the third antenna and connecting the filters in the RF filtering circuitry as described above, the RF front end circuitry may be capable of operating in one or more carrier aggregation configurations that were previously unachievable by conventional RF front end circuitry without the addition of any filters. Further, because the third antenna is configured to operate only at high-band frequencies, the size of the third antenna may be kept small in order to minimize the footprint of the RF front end circuitry.

In one embodiment, the mid/high-band operating band is one of long term evolution (LTE) band 1 and LTE band 25. The high-band operating band may be LTE band 41.

In one embodiment, RF front end circuitry includes a number of antennas, RF filtering circuitry, antenna switching circuitry coupled between the antennas and the RF filtering circuitry, and transceiver circuitry coupled to the RF filtering circuitry. The antennas include a first antenna, a second antenna, and a third antenna. The RF filtering circuitry is configured to isolate RF transmit signals and RF receive signals within a number of operating bands including a first operating band, a second operating band, a third operating band, a fourth operating band, a fifth operating band, a sixth operating band, a seventh operating band, and an eighth operating band. The RF front end circuitry is configured to operate in a standard configuration in which one or more filters in the RF filtering circuitry are coupled to two or more of the antennas via the antenna switching circuitry such that an RF transmit signal within one of the operating bands is provided to one of the antennas, and at least two RF receive signals within the same operating band are separately delivered from the antennas to the transceiver circuitry. Further, the RF front end circuitry is configured to operate in a carrier aggregation configuration in which one or more filters in the RF filtering circuitry are coupled to two or more of the antennas via the antenna switching circuitry such that an RF transmit signal within one of a set of the operating bands is delivered to one of the antennas, and at least two RF receive signals within each one of the set of operating bands are separately delivered from the antennas to the transceiver circuitry. By providing at least three antennas and connecting the filters in the RF filtering circuitry as described above, the RF front end circuitry may be capable of operating in one or more carrier aggregation configurations that were previously unachievable by conventional RF front end circuitry without the addition of any filters.

In one embodiment, the first antenna and the second antenna have an operating frequency between 1700 MHz and 2800 MHz, and the third antenna has an operating frequency between 2300 MHz and 2800 MHz. Because the third antenna is configured to operate only at high-band frequencies, the size of the third antenna may be kept small in order to minimize the footprint of the RF front end circuitry.

In one embodiment, the RF front end circuitry is configured to operate in a number of carrier aggregation configurations. Specifically, the RF front end circuitry may be configured to operate in a first carrier aggregation configuration in which the set of operating bands includes the first operating band, the second operating band, and the fourth operating band. In a second carrier aggregation configuration, the set of operating bands may include the third operating band, the fifth operating band, and the sixth operating band. In a third carrier aggregation configuration, the set of operating bands may include the second operating band and the eighth operating band. In a fourth carrier aggregation configuration, the set of operating bands may include the third operating band and the eighth operating band. In a fifth carrier aggregation configuration, the set of operating bands may include the seventh operating band and the eighth operating band.

In one embodiment, the first operating band is LTE band 4, the second operating band is LTE band 25, the third operating band is LTE band 1, the fourth operating band is LTE band 30, the fifth operating band is LTE band 3, the sixth operating band is LTE band 7, the seventh operating band is LTE band 39, and the eighth operating band is LTE band 41.

Those skilled in the art will appreciate the scope of the disclosure and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the disclosure, and together with the description serve to explain the principles of the disclosure.

FIGS. 1A and 1B show tables describing a number of wireless operating bands.

FIGS. 2A through 2D are diagrams illustrating a number of carrier aggregation configurations.

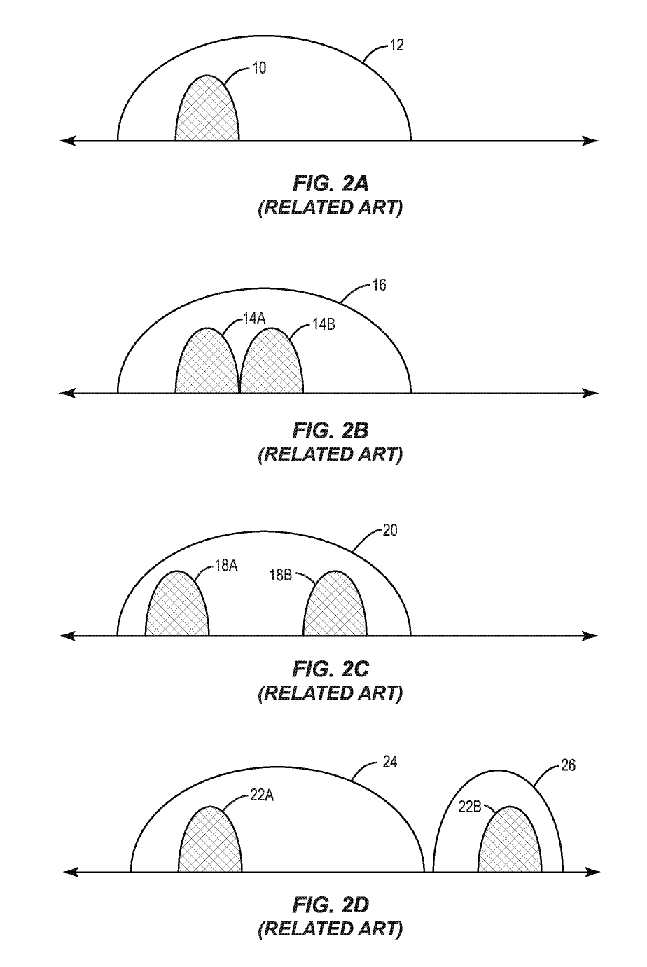

FIG. 3 is a functional schematic showing conventional radio frequency (RF) front end circuitry.

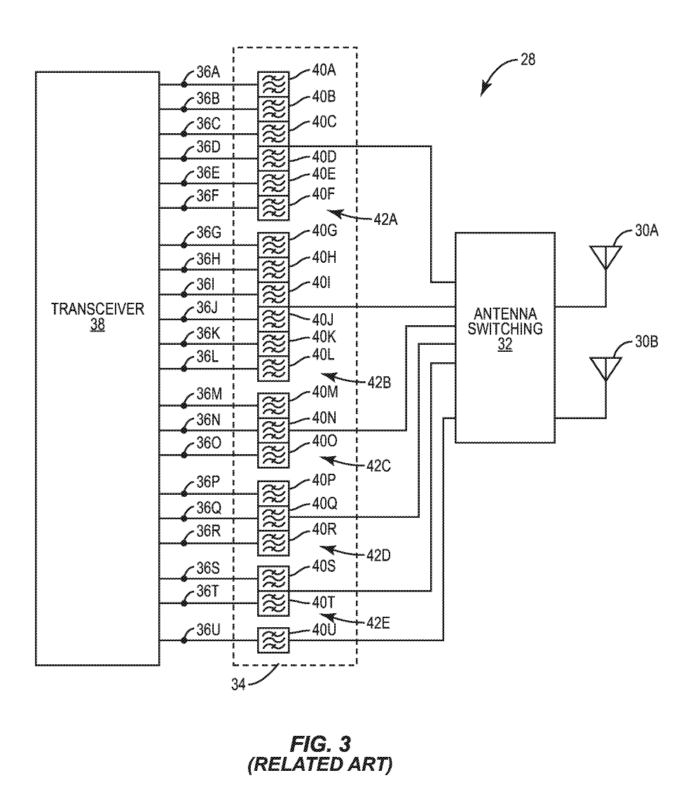

FIGS. 4A through 4F show details of filter circuitry for conventional RF front end circuitry.

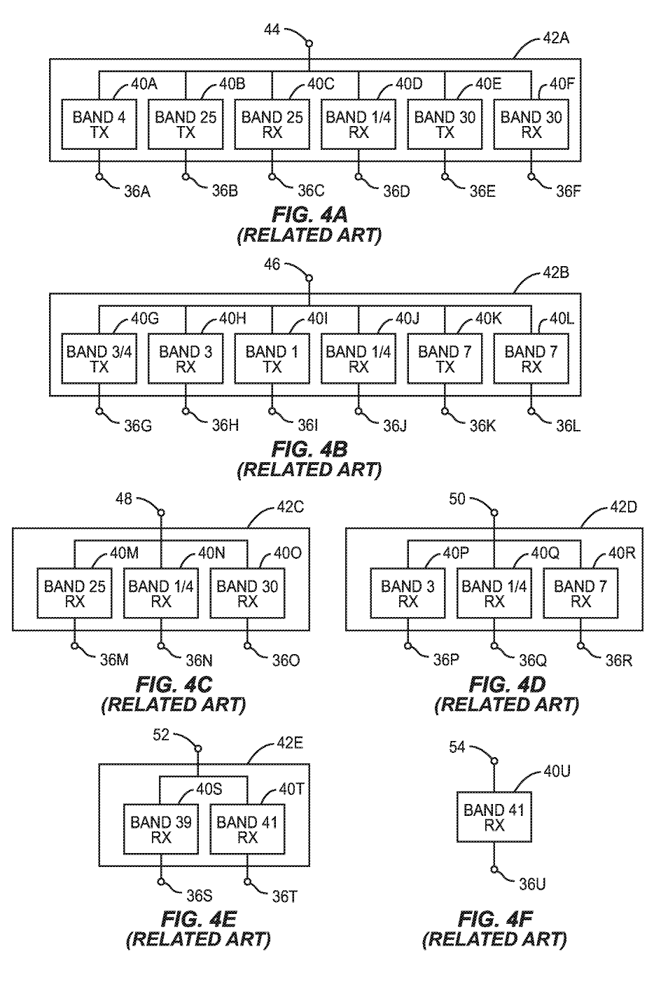

FIG. 5 is a functional schematic showing RF front end circuitry according to one embodiment of the present disclosure.

FIGS. 6A through 6F illustrate details of filter circuitry for RF front end circuitry according to one embodiment of the present disclosure.

FIG. 7 is a functional schematic showing RF front end circuitry according to one embodiment of the present disclosure.

FIGS. 8A through 8E illustrate details of filter circuitry for RF front end circuitry according to one embodiment of the present disclosure.

### DETAILED DESCRIPTION

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

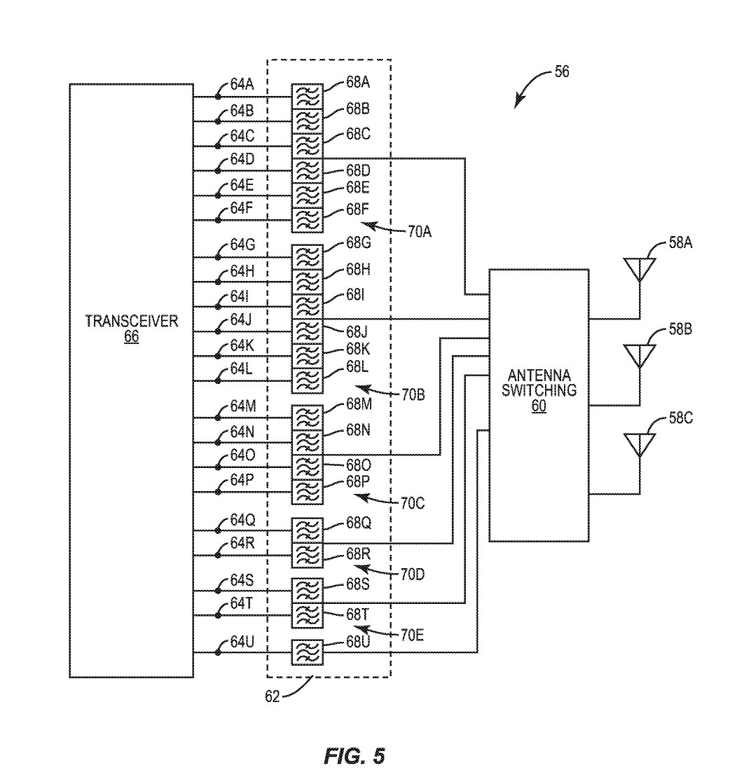

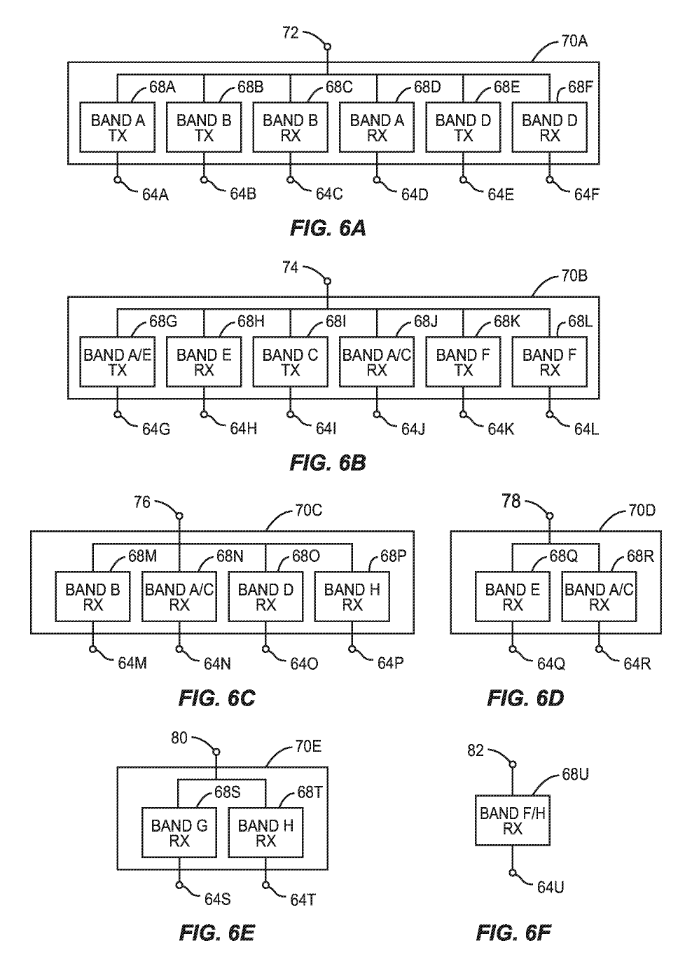

FIG. 5 shows a schematic representation of radio frequency (RF) front end circuitry 56 according to one embodiment of the present disclosure. The RF front end circuitry 56 includes a first antenna 58A, a second antenna 58B, a third antenna 58C, antenna switching circuitry 60 coupled to the first antenna 58A, the second antenna 58B, and the third antenna 58C, RF filtering circuitry 62 coupled between the antenna switching circuitry 60 and a number of input/output nodes 64 (shown individually as 64A through 64U), and transceiver circuitry 66 coupled to the input/output nodes 64. The RF filtering circuitry 62 includes a number of filters 68 (shown individually as 68A through 68U), which are grouped into first RF multiplexer circuitry 70A, second RF multiplexer circuitry 70B, third RF multiplexer circuitry 70C, fourth RF multiplexer circuitry 70D, and fifth RF multiplexer circuitry 70E. One of the filters 68U is not grouped with any other filters, as discussed below. The first RF multiplexer circuitry 70A and the second RF multiplexer circuitry 70B are hexaplexers, the third RF multiplexer circuitry 70C is a quadplexer, and the fourth RF multiplexer circuitry 70D and the fifth RF multiplexer circuitry 70E are diplexers. Details of the first RF multiplexer circuitry 70A, the second RF multiplexer circuitry 70B, the third RF multiplexer circuitry 70C, the fourth RF multiplexer circuitry 70D, and the fifth RF multiplexer circuitry 70E are shown below in FIGS. 6A through 6E.

FIG. 6A shows a block diagram of the first RF multiplexer circuitry 70A according to one embodiment of the present disclosure. The first RF multiplexer circuitry 70A includes a first filter 68A coupled between a first common node 72 and a first input/output node 64A, a second filter 68B coupled between the first common node 72 and a second input/output node 64B, a third filter 68C coupled between the first common node 72 and a third input/output node 64C, a fourth filter 68D coupled between the first common node 72 and a fourth input/output node 64D, a fifth filter 68E coupled between the first common node 72 and a fifth input/output node 64E, and a sixth filter 68F coupled between the first common node 72 and a sixth input/output node 64F.

FIG. 6B shows a block diagram of the second RF multiplexer circuitry 70B according to one embodiment of the present disclosure. The second RF multiplexer circuitry 70B includes a seventh filter 68G coupled between a second common node 74 and a seventh input/output node 64G, an eighth filter 68H coupled between the second common node 74 and an eighth input/output node 64H, a ninth filter 68I coupled between the second common node 74 and a ninth input/output node 64I, a tenth filter 68J coupled between the second common node 74 and a tenth input/output node 64J, an eleventh filter 68K coupled between the second common node 74 and an eleventh input/output node 64K, and a twelfth filter 68L coupled between the second common node 74 and a twelfth input/output node 64L.

FIG. 6C shows a block diagram of the third RF multiplexer circuitry 70C according to one embodiment of the present disclosure. The third RF multiplexer circuitry 70C includes a thirteenth filter 68M coupled between a third common node 76 and a thirteenth input/output node 64M, a fourteenth filter 68N coupled between the third common node 76 and a fourteenth input/output node 64N, a fifteenth filter 68O coupled between the third common node 76 and a fifteenth input/output node 64O, and a sixteenth filter 68P coupled between the third common node 76 and a sixteenth input/output node 64P.

FIG. 6D shows a block diagram of the fourth RF multiplexer circuitry 70D according to one embodiment of the present disclosure. The fourth RF multiplexer circuitry 70D includes a seventeenth filter 68Q coupled between a fourth common node 78 and a seventeenth input/output node 64Q and an eighteenth filter 68R coupled between the fourth common node 78 and an eighteenth input/output node 64R.

FIG. 6E shows a block diagram of the fifth RF multiplexer circuitry 70E according to one embodiment of the present disclosure. The fifth RF multiplexer circuitry 70E includes a nineteenth filter 68S coupled between a fifth common node 80 and a nineteenth input/output node 64S and a twentieth filter 68T coupled between the fifth common node 80 and a twentieth input/output node 64T.

FIG. 6F shows a twenty-first filter 68U coupled between an isolated filter node 82 and a twenty-first input/output node 64U, such that the twenty-first filter 68U is not grouped with any other filters.

The RF filtering circuitry 62 is configured to selectively pass RF transmit signals and RF receive signals within a first operating band (band A), a second operating band (band B), a third operating band (band C), a fourth operating band (band D), a fifth operating band (band E), a sixth operating band (band F), a seventh operating band (band G), and an eighth operating band (band H) between the antenna switching circuitry 60 and the transceiver circuitry 66. As discussed below, the RF filtering circuitry 62 facilitates all of the carrier aggregation configurations achievable by conventional RF front end circuitry and adds additional carrier aggregation configurations without additional filters.

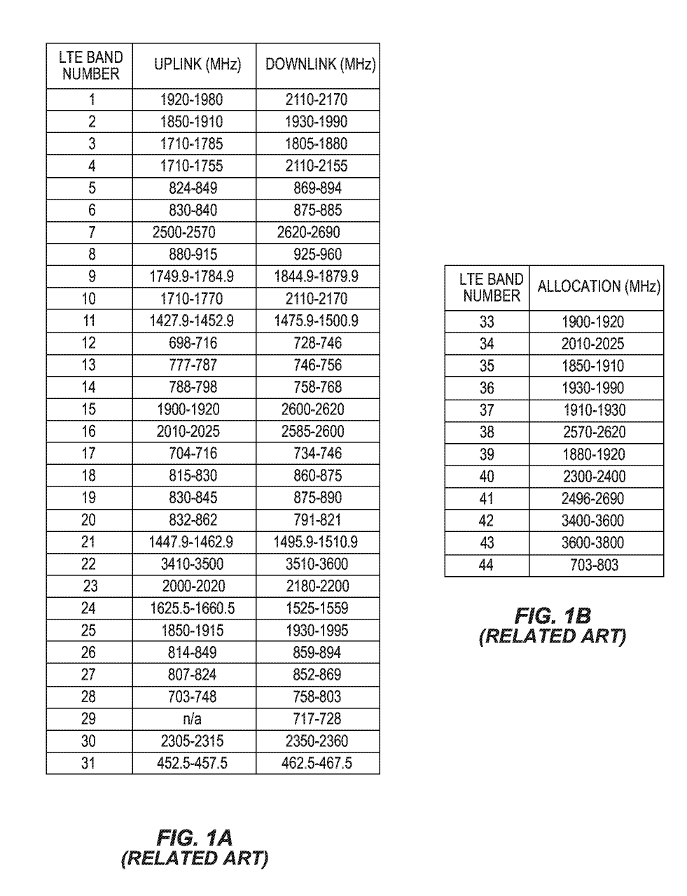

The filter response of each one of the filters 68 includes a pass band configured to pass RF signals within a particular frequency range, while attenuating other signals. Specifically, the pass band of each one of the filters 68 is designed to pass only those signals within a transmit or receive frequency band of a particular operating band (or multiple operating bands), such as the transmit and receive frequency bands shown above for each Third Generation Partnership Project (3GPP) Long Term Evolution (LTE) operating band in FIG. 1. The particular filter response of each one of the filters 68 in the RF filtering circuitry 62 is shown in Table 4:

| Filter | Pass band |
|---|---|
| First filter 68A | Band A (TX) |
| Second filter 68B | Band B (TX) |
| Third filter 68C | Band B (RX) |
| Fourth filter 68D | Band A (RX) |
| Fifth filter 68E | Band D (TX) |
| Sixth filter 68F | Band D (RX) |
| Seventh filter 68G | Band A/E (TX) |
| Eighth filter 68H | Band E (RX) |
| Ninth filter 68I | Band C (TX) |
| Tenth filter 68J | Band A/C (RX) |
| Eleventh filter 68K | Band F (TX) |
| Twelfth filter 68L | Band F (RX) |
| Thirteenth filter 68M | Band B (RX) |
| Fourteenth filter 68N | Band A/C (RX) |
| Fifteenth filter 68O | Band D (RX) |
| Sixteenth filter 68P | Band H (RX) |
| Seventeenth filter 68Q | Band E (RX) |
| Eighteenth filter 68R | Band A/C (RX) |
| Nineteenth filter 68S | Band G (RX) |
| Twentieth filter 68T | Band H (RX) |
| Twenty-first filter 68U | Band F/H (RX) |

The RF front end circuitry 56 is capable of operating in a standard (i.e., non-carrier aggregation) mode in any one of the first operating band (band A), the second operating band (band B), the third operating band (band C), the fourth operating band (band D), the fifth operating band (band E), and the sixth operating band (band F). Further, the RF front end circuitry 56 may receive but not transmit signals in the seventh operating band (band G), and the eighth operating band (band H). During standard modes, a first one of the antennas 58 is used to transmit and receive signals within a single operating band, while a second one of the antennas 58 is used to receive a diversity or multiple-input-multiple-output (MIMO) signal within the same operating band. The particular one of the antennas 58 used for transmission may be changed based on one or more performance characteristics of each one of the antennas 58 (e.g., voltage standing wave ratio), and may be dynamically swapped by the antenna switching circuitry 60 in order to optimize transmission and/or reception. Details of the connections made by the antenna switching circuitry 60 in each one of the standard configurations are described in Table 5:

Operating configurationAntenna connections

| | |
|---|---|
| Band A-standard | First RF multiplexer circuitry 70A |
| | Third RF multiplexer circuitry 70C |
| Band B-standard | First RF multiplexer circuitry 70A |
| | Third RF multiplexer circuitry 70C |
| Band C-standard | Second RF multiplexer circuitry 70B |
| | Fourth RF multiplexer circuitry 70D |
| Band D-standard | First RF multiplexer circuitry 70A |
| | Third RF multiplexer circuitry 70C |
| Band E-standard | Second RF multiplexer circuitry 70B |
| | Fourth RF multiplexer circuitry 70D |
| Band F-standard | Second RF multiplexer circuitry 70B |
| | Twenty-first filter 68U |
| Band G-standard (RX only) | Fifth RF multiplexer circuitry 70E (no |
| | diversity/MIMO) |
| Band H-standard (RX only) | Third RF multiplexer circuitry 70C |
| | Fifth RF multiplexer circuitry 70E |

The first column in Table 5 indicates the particular operating band in which the RF front end circuitry 56 is configured to transmit and/or receive RF signals. The second column in Table 5 indicates which filters 68 or groups of filters 68 in the RF filtering circuitry 62 are connected to either the first antenna 58A, the second antenna 58B, or the third antenna 58C. For most of the standard modes, a first filter 68 or group of filters 68 is connected to a first one of the antennas 58 for primary transmission and reception of RF signals within a particular operating band, while a second filter 68 or group of filters 68 is connected to a second one of the antennas 58 for reception of diversity or MIMO receive signals within the same operating band. In some configurations (e.g., in TDD operating bands such as the seventh operating band, band G), however, diversity or MIMO signals may not be used. In general, the filters 68 in the first RF multiplexer circuitry 70A, the second RF multiplexer circuitry 70B, and the fifth RF multiplexer circuitry 70E are used to transmit and receive primary signals, while the filters 68 in the third RF multiplexer circuitry 70C, the fourth RF multiplexer circuitry 70D, and the twenty-first filter 68U are used for the reception of diversity or MIMO receive signals. When connected to an antenna 58, the particular filter 68 or group of filters 68 isolates RF receive signals from the antenna 58 that are within the receive band of the operating band from other signals and delivers the isolated RF receive signals to the transceiver circuitry 66 for further processing. Further, the particular filter 68 or group of filters 68 passes RF transmit signals within the operating band provided at the appropriate input/output node 64 to the connected antenna 58 for transmission.

The RF front end circuitry 56 may operate in a first carrier aggregation configuration in which bandwidth is aggregated between the first operating band (band A), the second operating band (band B), and the fourth operating band (band D), a second carrier aggregation configuration in which bandwidth is aggregated between the third operating band (band C), the fifth operating band (band E), and the sixth operating band (band F), a third carrier aggregation configuration in which bandwidth is aggregated between the seventh operating band (band G) and the eighth operating band (band H), a fourth carrier aggregation configuration in which bandwidth is aggregated between the second operating band (band B) and the eighth operating band (band H), and a fifth carrier aggregation configuration in which bandwidth is aggregated between the third operating band (band C) and the eighth operating band (band H). Details of the connections made by the antenna switching circuitry 60 in each one of the carrier aggregation configurations are described in Table 6:

| Operating configuration | Antenna connections |
|---|---|
| Bands A-B-D (carrier | First RF multiplexer circuitry 70A |
| aggregation) | Third RF multiplexer circuitry 70C |
| Bands C-E-F (carrier | Second RF multiplexer circuitry 70B |
| aggregation) | Fourth RF multiplexer circuitry 70D |
| | Twenty-first filter 68U |
| Bands G-H (carrier aggregation- | Third RF multiplexer circuitry 70C |
| RX only) | Fifth RF multiplexer circuitry 70E (first |
| | antenna 58A or second antenna 58B) |
| Bands B-H (carrier aggregation) | First RF multiplexer circuitry 70A |
| | Third RF multiplexer circuitry 70C |
| | Fifth RF multiplexer circuitry 70E (third |
| | antenna 58C) |
| Bands C-H (carrier aggregation) | Second RF multiplexer circuitry 70B |
| | Fourth RF multiplexer circuitry 70D |
| | Fifth RF multiplexer circuitry 70E (third |
| | antenna 58C) |

The first column in Table 6 indicates the particular operating bands in which the RF front end circuitry 56 is configured to aggregate bandwidth. The second column in Table 6 indicates which filters or groups of filters in the RF filtering circuitry 62 are connected to one of the antennas 58. For most of the carrier aggregation configurations, a first filter 68 or group of filters 68 is connected to a first one of the antennas 58 for primary transmission and reception of RF signals within the particular operating bands, while a second filter 68 or group of filters 68 is connected to a second one of the antennas 58 for reception of diversity or MIMO receive signals within the one or more of the same operating bands. Further, a third filter 68 or group of filters 68 may be connected to a third one of the antennas 58 for reception of primary, diversity, or MIMO receive signals within one or more of the same operating bands. Generally, transmission of RF signals occurs only within one of the operating bands, while reception occurs on all of the indicated operating bands. In the first and second carrier aggregation configurations shown, any one of the operating bands may be used for transmission and reception, while the remaining bands are used only for reception. In the third carrier aggregation configuration, signals are only received, and not transmitted on either operating band. In the fourth and fifth carrier aggregation configurations, signals are transmitted on the first listed operating band and received on the second listed operating band. When connected to an antenna 58, the particular filter 68 or group of filters 68 isolates RF receive signals from the antenna 58 that are within the receive bands of the operating bands from other signals and delivers the isolated RF receive signals to the transceiver circuitry 38 for further processing. Further, the particular filter 68 or group of filters 68 passes RF transmit signals within the one of the operating bands provided at the appropriate input/output node 64 to the connected antenna 58 for transmission.

The third antenna 58C may be specifically designed to support the reception of signals within a relatively narrow frequency band, and specifically may be designed to support the reception only of high-band signals. In contrast, the first antenna 58A and the second antenna 58B may be specifically designed to support the transmission and reception of both mid-band frequencies and high-band frequencies, referred to herein as mid/high-band frequencies. As defined herein, mid/high-band frequencies are frequencies between 1700 MHz and 2800 MHz, while high-band frequencies are frequencies between 2300 MHz and 2800 MHz. Accordingly, an operating frequency of the first antenna 58A and the second antenna 58B may be between 1700 MHz and 2800 MHz, while an operating frequency of the third antenna 58C may be between 2300 MHz and 2800 MHz. Providing the third antenna 58C such that it is designed as a high-band antenna allows the third antenna 58C to remain small when compared to the first antenna 58A and the second antenna 58B (since the operating frequency of an antenna is inversely related to the size thereof), thereby consuming less space in the RF front end circuitry 56. In an additional embodiment, the third antenna 58C may be designed to support an even narrower frequency range such as the receive frequency band of the eighth operating band (band H).

In one embodiment, the first operating band (band A) is long term evolution (LTE) operating band 4, the second operating band (band B) is LTE operating band 25, the third operating band (band C) is LTE operating band 1, the fourth operating band (band D) is LTE operating band 30, the fifth operating band (band E) is LTE operating band 3, the sixth operating band (band F) is LTE operating band 7, the seventh operating band (band G) is LTE operating band 39, and the eighth operating band (band H) is LTE operating band 41. The particular transmit and receive frequency bands for these operating bands are shown above in FIG. 1. The concepts of the present disclosure may similarly be applied to any number of different operating bands.

The various transmit and receive frequency bands of the operating bands and the antennas 58 are taken into account when connecting a particular one of the antennas 58 to the RF filtering circuitry 62. As discussed above, the third antenna 58C may be designed for a relatively narrow range of frequencies. In one embodiment, the third antenna 58C is thus configured to support the reception of signals within the eighth operating band (band H), but not the seventh operating band (band G). Accordingly, the fifth RF multiplexer circuitry 70E is only connected to the third antenna 58C when receiving signals only on the eighth operating band (band H), such as in the fourth and fifth carrier aggregation configurations discussed above. In the third carrier aggregation in which signals are received in both the seventh operating band (band G) and the eight operating band (band H), the fifth RF multiplexer circuitry 70E must be connected to one of the first antenna 58A and the second antenna 58B so that RF receive signals within the seventh operating band (band G) may be properly received.

Adding the third antenna 58C and arranging the filters 68 as discussed above allows the RF front end circuitry 56 to support the fourth and fifth carrier aggregations shown above in Table 6 without the introduction of any additional filters. Further, doing so results in minimal impact on the performance of the RF front end circuitry 56 when compared to conventional designs.

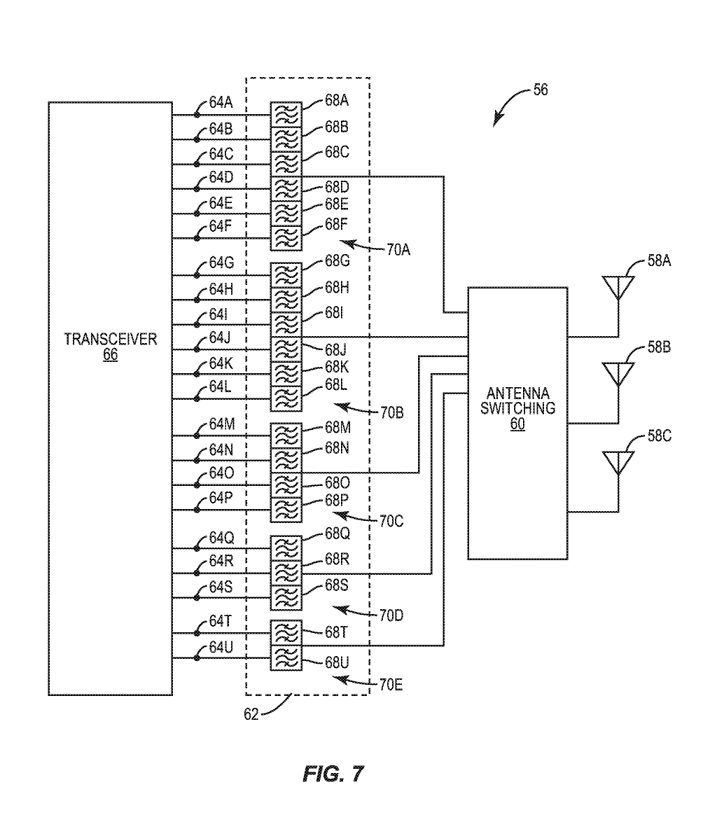

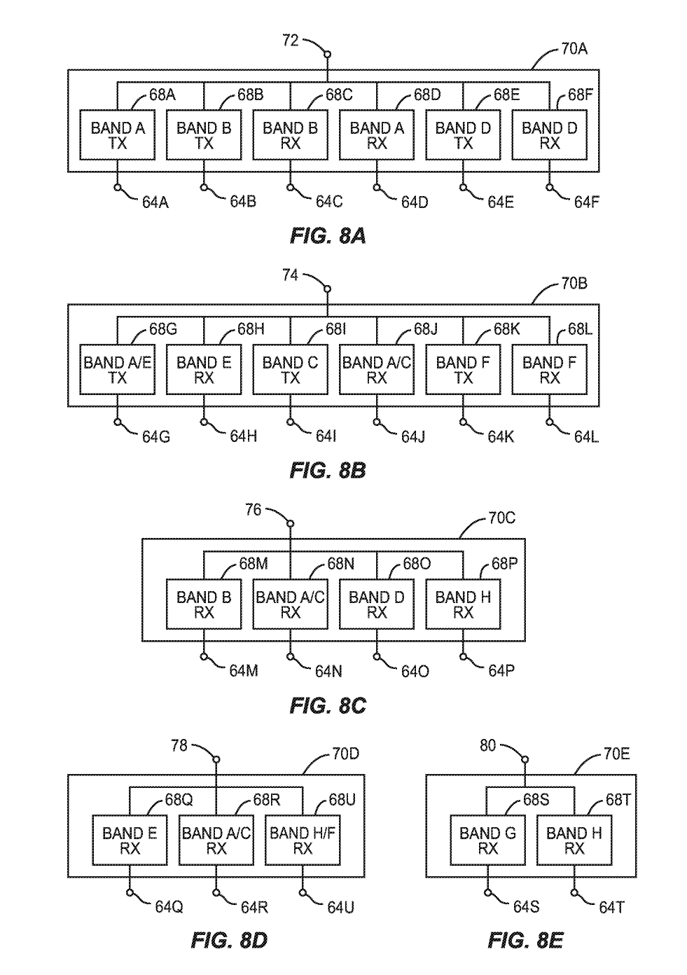

FIG. 7 shows the RF front end circuitry 56 according to an additional embodiment of the present disclosure. The RF front end circuitry 56 shown in FIG. 7 is substantially similar to that shown in FIG. 5, except that the twenty-first filter 68U is moved into the fourth RF multiplexer circuitry 70D, such that the fourth RF multiplexer circuitry 70D is a triplexer rather than a diplexer. FIGS. 8A through 8E show details of the first RF multiplexer circuitry 70A, the second RF multiplexer circuitry 70B, the third RF multiplexer circuitry 70C, the fourth RF multiplexer circuitry 70D, and the fifth RF multiplexer circuitry 70E. Due to the arrangement of the filters 68 in the RF front end circuitry shown in FIGS. 7 and 8A through 8E, the connections made by the antenna switching circuitry 60 are slightly modified in both standard and carrier aggregation configurations. Table 7 shows details of the connections made by the antenna switching circuitry 60 in the standard modes:

| Operating configuration | Antenna connections |
|---|---|
| Band A-standard | First RF multiplexer circuitry 70A |
| | Third RF multiplexer circuitry 70C |
| Band B-standard | First RF multiplexer circuitry 70A |
| | Third RF multiplexer circuitry 70C |
| Band C-standard | Second RF multiplexer circuitry 70B |
| | Fourth RF multiplexer circuitry 70D |
| Band D-standard | First RF multiplexer circuitry 70A |
| | Third RF multiplexer circuitry 70C |
| Band E-standard | Second RF multiplexer circuitry 70B |
| | Fourth RF multiplexer circuitry 70D |
| Band F-standard | Second RF multiplexer circuitry 70B |
| | Fourth RF multiplexer circuitry 70D |
| Band G-standard (RX only) | Fifth RF multiplexer circuitry 70E (no |
| | diversity/MIMO) |
| Band H-standard (RX only) | Third RF multiplexer circuitry 70C |
| | Fifth RF multiplexer circuitry 70E |

Further, the connections made by the antenna switching circuitry 60 in the carrier aggregation configurations are shown in Table 8:

| Operating configuration | Antenna connections |
|---|---|
| Bands A-B-D (carrier | First RF multiplexer circuitry 70A |
| aggregation) | Third RF multiplexer circuitry 70C |
| Bands C-E-F (carrier | Second RF multiplexer circuitry 70B |
| aggregation) | Fourth RF multiplexer circuitry 70D |
| Bands G-H (carrier aggregation- | Third RF multiplexer circuitry 70C |
| RX only) | Fifth RF multiplexer circuitry 70E (first |
| | antenna 58A or second antenna 58B) |
| Bands B-H (carrier aggregation) | First RF multiplexer circuitry 70A |
| | Third RF multiplexer circuitry 70C |
| | Fifth RF multiplexer circuitry 70E |
| | (third antenna 58C) |
| Bands C-H (carrier aggregation) | Second RF multiplexer circuitry 70B |
| | Fourth RF multiplexer circuitry 70D |
| | Fifth RF multiplexer circuitry 70E |
| | (third antenna 58C) |

As shown above, when operating in a standard mode in the sixth operating band, the fourth RF multiplexer circuitry 70D is coupled to one of the antennas 58 instead of the twenty-first filter 68U as in the previous configuration. Further, in the second carrier aggregation configuration, only the second RF multiplexer circuitry 70B and the fourth RF multiplexer circuitry 70D are coupled to the antennas 58. Once again, the particular arrangement of the filters and the use of the third antenna 58C in certain configurations allows the RF front end circuitry to support all of the carrier aggregation configurations described above without adding any additional filters over conventional RF front end circuitry.

Those skilled in the art will recognize improvements and modifications to the embodiments of the present disclosure. All such improvements and modifications are considered within the scope of the concepts disclosed herein and the claims that follow.

What is claimed is:

1. Radio frequency (RF) front end circuitry comprising:
a plurality of antennas including a first antenna, a second antenna, and a third antenna, wherein the first antenna and the second antenna are configured to operate at mid/high-band frequencies, and the third antenna is configured to operate only at high-band frequencies;
RF filtering circuitry;
antenna switching circuitry coupled between the plurality of antennas and the RF filtering circuitry; and
transceiver circuitry coupled to the RF filtering circuitry;
wherein the RF front end circuitry is configured to:
connect one or more mid/high-band filters in the RF filtering circuitry to the first antenna and the second antenna via the antenna switching circuitry such that an RF transmit signal within a mid/high-band operating band is provided to one of the first antenna and the second antenna, and at least two RF receive signals within the mid/high-band operating band received at the first antenna and the second antenna, respectively, are separately delivered to the transceiver circuitry; and
connect one or more high-band filters in the RF filtering circuitry to the second antenna and the third antenna via the antenna switching circuitry such that at least two RF receive signals within a high-band operating band received at the second antenna and the third antenna, respectively, are separately delivered to the transceiver circuitry.

2. The RF front end circuitry of claim 1 wherein:
the mid/high-band operating band is one of long term evolution (LTE) band 1 and LTE band 25; and
the high-band operating band is LTE band 41.

3. Radio frequency (RF) front end circuitry comprising:
a plurality of antennas including a first antenna, a second antenna, and a third antenna;
RF filtering circuitry configured to isolate RF transmit signals and RF receive signals within a plurality of operating bands, the plurality of operating bands including a first operating band, a second operating band, a third operating band, a fourth operating band, a fifth operating band, a sixth operating band, a seventh operating band, and an eighth operating band;
antenna switching circuitry coupled between the plurality of antennas and the RF filtering circuitry; and
transceiver circuitry coupled to the RF filtering circuitry;
wherein the RF front end circuitry is configured to:
in a standard configuration, couple one or more filters in the RF filtering circuitry to two or more of the plurality of antennas via the antenna switching circuitry such that an RF transmit signal within one of the plurality of operating bands is provided to one of the plurality of antennas, and at least two RF receive signals within the one of the plurality of operating bands are separately delivered from different ones of the plurality of antennas to the transceiver circuitry; and
in a carrier aggregation configuration, couple one or more filters in the RF filtering circuitry to two or more of the plurality of antennas via the antenna switching circuitry such that an RF transmit signal within one of a set of the plurality of operating bands is delivered to one of the plurality of antennas, and at least two RF receive signals within each one of the set of the plurality of operating bands are separately delivered from different ones of the plurality of antennas to the transceiver circuitry.

4. The RF front end circuitry of claim 3 wherein:
the first antenna and the second antenna have an operating frequency between 1700 MHz and 2800 MHz; and
the third antenna has an operating frequency between 2300 MHz and 2800 MHz.

5. The RF front end circuitry of claim 4 wherein the RF front end circuitry is further configured to:
operate in a first carrier aggregation configuration in which the set of the plurality of operating bands includes the first operating band, the second operating band, and the fourth operating band;
operate in a second carrier aggregation configuration in which the set of the plurality of operating bands includes the third operating band, the fifth operating band, and the sixth operating band;
operate in a third carrier aggregation configuration in which the set of the plurality of operating bands includes the seventh operating band and the eighth operating band;
operate in a fourth carrier aggregation configuration in which the set of the plurality of operating bands includes the second operating band and the eighth operating band; and
operate in a fifth carrier aggregation configuration in which the set of the plurality of operating bands includes the third operating band and the eighth operating band.

6. The RF front end circuitry of claim 5 wherein:
the first operating band is long term evolution (LTE) band 4;
the second operating band is LTE band 25;
the third operating band is LTE band 1;
the fourth operating band is LTE band 30;
the fifth operating band is LTE band 3;
the sixth operating band is LTE band 7;
the seventh operating band is LTE band 39; and
the eighth operating band is LTE band 41.

7. The RF front end circuitry of claim 6 wherein the RF filtering circuitry comprises:
first RF multiplexer circuitry configured to isolate RF transmit signals in the first operating band, RF transmit signals in the second operating band, RF receive signals in the second operating band, RF receive signals in the first operating band, RF transmit signals in the fourth operating band, and RF receive signals in the fourth operating band;
second RF multiplexer circuitry configured to isolate RF transmit signals in the first operating band and the fifth operating band, RF receive signals in the fifth operating band, RF transmit signals in the third operating band, RF receive signals in the first operating band and the third operating band, RF transmit signals in the sixth operating band, and RF receive signals in the sixth operating band;
third RF multiplexer circuitry configured to isolate RF receive signals in the second operating band, RF receive signals in the first operating band and the third operating band, RF receive signals in the fourth operating band, and RF receive signals in the eighth operating band;
fourth multiplexer circuitry configured to isolate RF receive signals in the fifth operating band and RF receive signals in the first operating band and the third operating band;
fifth multiplexer circuitry configured to isolate RF receive signals in the seventh operating band and RF receive signals in the eighth operating band; and
an isolated filter configured to isolate RF receive signals in the eighth operating band.

8. The RF front end circuitry of claim 7 wherein:
the first RF multiplexer circuitry is a hexaplexer;
the second RF multiplexer circuitry is a hexaplexer;
the third RF multiplexer circuitry is a quadplexer;
the fourth RF multiplexer circuitry is a diplexer; and
the fifth RF multiplexer circuitry is a diplexer.

9. The RF front end circuitry of claim 5 wherein the RF filtering circuitry comprises:
first RF multiplexer circuitry configured to isolate RF transmit signals in the first operating band, RF transmit signals in the second operating band, RF receive signals in the second operating band, RF receive signals in the first operating band, RF transmit signals in the fourth operating band, and RF receive signals in the fourth operating band;
second RF multiplexer circuitry configured to isolate RF transmit signals in the first operating band and the fifth operating band, RF receive signals in the fifth operating band, RF transmit signals in the third operating band, RF receive signals in the first operating band and the third operating band, RF transmit signals in the sixth operating band, and RF receive signals in the sixth operating band;
third RF multiplexer circuitry configured to isolate RF receive signals in the second operating band, RF receive signals in the first operating band and the third operating band, RF receive signals in the fourth operating band, and RF receive signals in the eighth operating band;
fourth multiplexer circuitry configured to isolate RF receive signals in the fifth operating band, RF receive signals in the first operating band and the third operating band; and
fifth multiplexer circuitry configured to isolate RF receive signals in the seventh operating band and RF receive signals in the eighth operating band.

10. The RF front end circuitry of claim 9 wherein:
the first RF multiplexer circuitry is a hexaplexer;
the second RF multiplexer circuitry is a hexaplexer;
the third RF multiplexer circuitry is a quadplexer;
the fourth RF multiplexer circuitry is a diplexer; and
the fifth RF multiplexer circuitry is a diplexer.

11. The RF front end circuitry of claim 6 wherein the RF filtering circuitry comprises:
first RF multiplexer circuitry configured to isolate RF transmit signals in the first operating band, RF transmit signals in the second operating band, RF receive signals in the second operating band, RF receive signals in the first operating band, RF transmit signals in the fourth operating band, and RF receive signals in the fourth operating band;
second RF multiplexer circuitry configured to isolate RF transmit signals in the first operating band and the fifth operating band, RF receive signals in the fifth operating band, RF transmit signals in the third operating band, RF receive signals in the first operating band and the third operating band, RF transmit signals in the sixth operating band, and RF receive signals in the sixth operating band;
third RF multiplexer circuitry configured to isolate RF receive signals in the second operating band, RF receive signals in the first operating band and the third operating band, RF receive signals in the fourth operating band, and RF receive signals in the eighth operating band;
fourth multiplexer circuitry configured to isolate RF receive signals in the fifth operating band, RF receive signals in the first operating band and the third operating band, and RF receive signals in the eighth operating band; and
fifth multiplexer circuitry configured to isolate RF receive signals in the seventh operating band and RF receive signals in the eighth operating band.

12. The RF front end circuitry of claim 11 wherein:
the first RF multiplexer circuitry is a hexaplexer;
the second RF multiplexer circuitry is a hexaplexer;
the third RF multiplexer circuitry is a quadplexer;
the fourth RF multiplexer circuitry is a triplexer; and
the fifth RF multiplexer circuitry is a diplexer.

13. The RF front end circuitry of claim 5 wherein the RF filtering circuitry comprises:
first RF multiplexer circuitry configured to isolate RF transmit signals in the first operating band, RF transmit signals in the second operating band, RF receive signals in the second operating band, RF receive signals in the first operating band, RF transmit signals in the fourth operating band, and RF receive signals in the fourth operating band;
second RF multiplexer circuitry configured to isolate RF transmit signals in the first operating band and the fifth operating band, RF receive signals in the fifth operating band, RF transmit signals in the third operating band, RF receive signals in the first operating band and the third operating band, RF transmit signals in the sixth operating band, and RF receive signals in the sixth operating band;
third RF multiplexer circuitry configured to isolate RF receive signals in the second operating band, RF receive signals in the first operating band and the third operating band, RF receive signals in the fourth operating band, and RF receive signals in the eighth operating band;
fourth multiplexer circuitry configured to isolate RF receive signals in the fifth operating band, RF receive signals in the first operating band and the third operating band, and RF receive signals in the eighth operating band; and
fifth multiplexer circuitry configured to isolate RF receive signals in the seventh operating band and RF receive signals in the eighth operating band.

14. The RF front end circuitry of claim 13 wherein:
the first RF multiplexer circuitry is a hexaplexer;
the second RF multiplexer circuitry is a hexaplexer;
the third RF multiplexer circuitry is a quadplexer;
the fourth RF multiplexer circuitry is a triplexer; and
the fifth RF multiplexer circuitry is a diplexer.

15. The RF front end circuitry of claim 4 wherein the RF front end circuitry is further configured to:
operate in a first carrier aggregation configuration in which the set of the plurality of operating bands includes the first operating band, the second operating band, and the fourth operating band;
operate in a second carrier aggregation configuration in which the set of the plurality of operating bands includes the third operating band, the fifth operating band, and the sixth operating band;
operate in a third carrier aggregation configuration in which the set of the plurality of operating bands includes the second operating band and the eighth operating band;
operate in a fourth carrier aggregation configuration in which the set of the plurality of operating bands includes the third operating band and the eighth operating band; and
operate in a fifth carrier aggregation configuration in which the set of the plurality of operating bands includes the seventh operating band and the eighth operating band.

16. The RF front end circuitry of claim 15 wherein:
the first operating band is long term evolution (LTE) band 4;
the second operating band is LTE band 25;
the third operating band is LTE band 1;
the fourth operating band is LTE band 30;
the fifth operating band is LTE band 3;
the sixth operating band is LTE band 7;
the seventh operating band is LTE band 39; and
the eighth operating band is LTE band 41.

17. The RF front end circuitry of claim 16 wherein the RF filtering circuitry comprises:
first RF multiplexer circuitry configured to isolate RF transmit signals in the first operating band, RF transmit signals in the second operating band, RF receive signals in the second operating band, RF receive signals in the first operating band, RF transmit signals in the fourth operating band, and RF receive signals in the fourth operating band;
second RF multiplexer circuitry configured to isolate RF transmit signals in the first operating band and the fifth operating band, RF receive signals in the fifth operating band, RF transmit signals in the third operating band, RF receive signals in the first operating band and the third operating band, RF transmit signals in the sixth operating band, and RF receive signals in the sixth operating band;
third RF multiplexer circuitry configured to isolate RF receive signals in the second operating band, RF receive signals in the first operating band and the third operating band, RF receive signals in the fourth operating band, and RF receive signals in the eighth operating band;
fourth multiplexer circuitry configured to isolate RF receive signals in the fifth operating band and RF receive signals in the first operating band and the third operating band;
fifth multiplexer circuitry configured to isolate RF receive signals in the seventh operating band and RF receive signals in the eighth operating band; and
an isolated filter configured to isolate RF receive signals in the eighth operating band.

18. The RF front end circuitry of claim 17 wherein:
the first RF multiplexer circuitry is a hexaplexer;
the second RF multiplexer circuitry is a hexaplexer;
the third RF multiplexer circuitry is a quadplexer;
the fourth RF multiplexer circuitry is a diplexer; and
the fifth RF multiplexer circuitry is a diplexer.

19. The RF front end circuitry of claim 16 wherein the RF filtering circuitry comprises:
first RF multiplexer circuitry configured to isolate RF transmit signals in the first operating band, RF transmit signals in the second operating band, RF receive signals in the second operating band, RF receive signals in the first operating band, RF transmit signals in the fourth operating band, and RF receive signals in the fourth operating band;
second RF multiplexer circuitry configured to isolate RF transmit signals in the first operating band and the fifth operating band, RF receive signals in the fifth operating band, RF transmit signals in the third operating band, RF receive signals in the first operating band and the third operating band, RF transmit signals in the sixth operating band, and RF receive signals in the sixth operating band;
third RF multiplexer circuitry configured to isolate RF receive signals in the second operating band, RF receive signals in the first operating band and the third operating band, RF receive signals in the fourth operating band, and RF receive signals in the eighth operating band;
fourth multiplexer circuitry configured to isolate RF receive signals in the fifth operating band, RF receive signals in the first operating band and the third operating band, and RF receive signals in the eighth operating band; and
fifth multiplexer circuitry configured to isolate RF receive signals in the seventh operating band and RF receive signals in the eighth operating band.

20. The RF front end circuitry of claim 19 wherein:
the first RF multiplexer circuitry is a hexaplexer;
the second RF multiplexer circuitry is a hexaplexer;
the third RF multiplexer circuitry is a quadplexer;
the fourth RF multiplexer circuitry is a triplexer; and
the fifth RF multiplexer circuitry is a diplexer.
